(19) United States
(12) Patent Application Publication
(10) Pub. No.: US 2013/0248612 A1
(43) Pub. Date: Sep. 26, 2013

(54) Solenoid Actuator And Fuel Injector Using Same

(71) Applicants: Sudhindra K. Ayanji, Edwards, IL (US); Gregory Alan Weyeneth, Dunlap, IL (US); Jayaraman K. Venkataraghavan, Dunlap, IL (US); Nadeem Bunni, Cranberry Township, PA (US)

(72) Inventors: Sudhindra K. Ayanji, Edwards, IL (US); Gregory Alan Weyeneth, Dunlap, IL (US); Jayaraman K. Venkataraghavan, Dunlap, IL (US); Nadeem Bunni, Cranberry Township, PA (US)

(73) Assignee: CATERPILLAR INC., Peoria, IL (US)

(21) Appl. No.: 13/429,882

(22) Filed: Mar. 26, 2012

(51) Int. Cl. F02D 1/06; F16K 31/02; F02M 45/10

(52) U.S. Cl. 239/5; 239/95; 251/129.01

(57) ABSTRACT

Starting and ending an injection event are accomplished by respectively energizing and de-energizing a solenoid actuator to move an armature assembly with respect to a stator. The stator is protected from impact damage by maintaining the armature assembly out of contact with the stator. The inducement of residual magnetism in the armature assembly is reduced by stopping the armature assembly at a large radius outside of the magnetic flux circuit through the stator and soft magnetic armature of the armature assembly, when the solenoid actuator is energized.

### TECHNICAL FIELD

The present disclosure relates generally to stopping an armature of a solenoid actuator, and more specifically to a fuel injector with an armature assembly that includes a soft magnetic armature and a hard non-magnetic stop piece.

### BACKGROUND

One class of fuel injectors for common rail compression ignition engines include a single solenoid actuator to relieve and apply pressure to a closing hydraulic surface of a direct control needle valve. Fuel injection events are typically initiated by energizing the solenoid, and opening a valve responsive to movement of an armature assembly toward a stator. Injection events are ended by de-energizing the solenoid to allow the valve to reclose to resume pressure on the closing hydraulic surface of the direct control needle valve. Performance advantages have been observed by providing a solenoid actuator with the ability to precisely control injection sequences that include short dwell times separating substantial injection quantities from precisely controlled small injection quantities.

In an effort to improve performance in limited spatial envelopes, engineers have adopted a variety of materials to accommodate the various needs of a complete solenoid actuator. For instance, a highly magnetic but extremely fragile compound, which is sometimes referred to as somaloy, is attractive for use in stators for solenoid assemblies. Other components, such as the piece that links a soft magnetic armature to the valve member, might include a relatively hard non-magnetic high impact material. Although utilization of various materials for different components of solenoid actuator have incrementally improved performance, new problems continue to occur, and old problems endure making design changes to improve precise, consistent and robust performance elusive.

The present disclosure is directed toward improving upon solenoid actuators for fuel injectors.

### SUMMARY

In one aspect, a fuel injector includes an injector body that defines a fuel inlet and a plurality of nozzle outlets, and includes a stop surface. A direct control needle valve has a closing hydraulic surface positioned in a needle control chamber. A solenoid actuator has an armature assembly that moves as a unit with respect to a stator between an initial air gap position and a final air gap position, such that the armature assembly is always out of contact with the stator. The armature assembly includes a soft magnetic armature and a hard non-magnetic stop piece, which is located further from the stator than the armature. The stop piece is in contact with the stop surface at the final air gap position, but is out of contact with the stop surface at the initial air gap position.

In another aspect, a solenoid actuator includes an actuator body with a stop surface. A stator is mounted to the actuator body and has a centerline. An armature assembly moves between an initial air gap position and a final air gap position. The armature assembly includes a soft magnetic armature and a hard non-magnetic stop piece that are each attached to a pin at a small radius from the centerline. The stop piece is in contact with the stop surface at a large radius from the centerline when at the final air gap position, but is out of contact with the stop surface at the initial air gap position.

In still another aspect, a method of injecting fuel includes starting an injection event by energizing a solenoid actuator, and ending the injection event by de-energizing the solenoid actuator. The energizing step includes moving an armature assembly toward a stator. The stator is protected from impact damage by maintaining the armature assembly out of contact with the stator. Residual magnetism in the armature assembly is reduced by stopping the armature assembly outside of a magnetic flux circuit through the stator and soft magnetic armature of the armature assembly, when the solenoid actuator is energized.

### BRIEF DESCRIPTION OF THE DRAWINGS

FIG. 1 is a front sectioned view of a fuel injector according to the present disclosure;

FIG. 2 is an enlarged front sectioned view of the solenoid actuator portion of the fuel injector of FIG. 1;

FIG. 3 is a front sectioned view of an armature assembly according to another embodiment of the present disclosure;

FIG. 4 is a sectioned perspective view of the armature assembly of FIG. 3;

FIG. 5 is a top view of an armature stop spacer according to the embodiment of FIG. 3; and

FIG. 6 is a top view of the armature assembly of FIG. 3.

### DETAILED DESCRIPTION

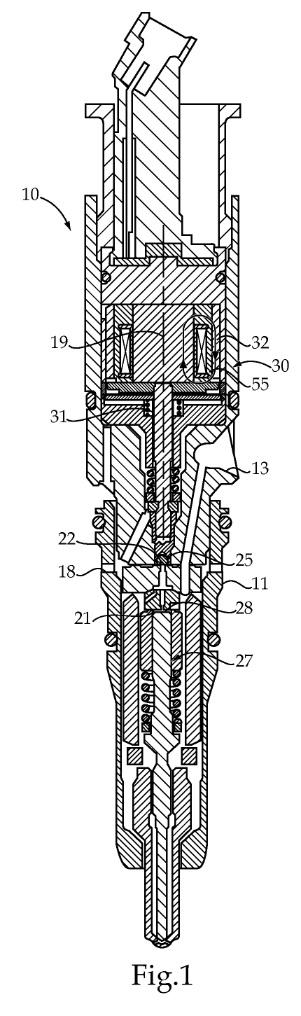

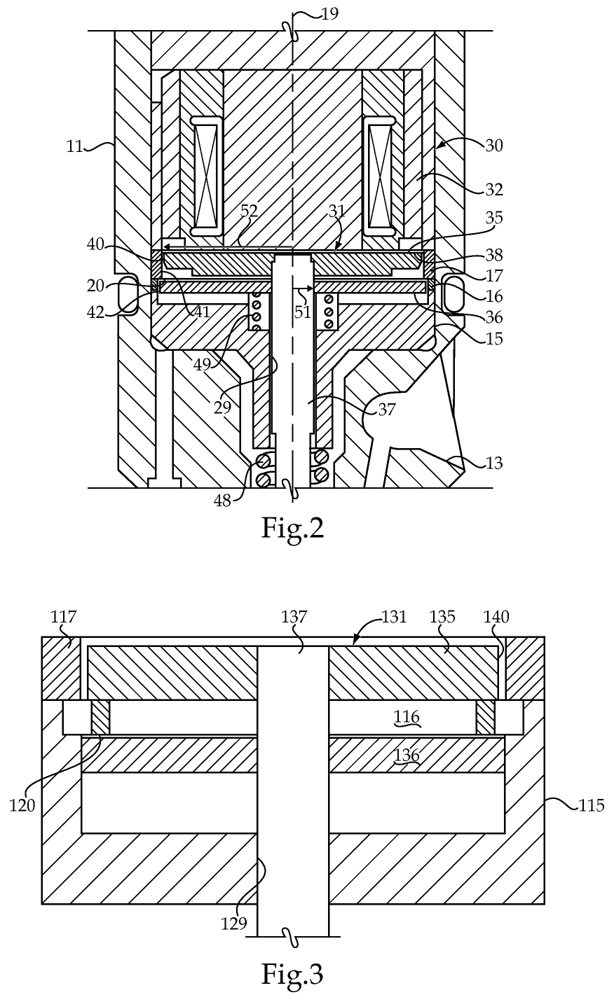

Referring to FIGS. 1 and 2, a fuel injector 10 includes an injector body 11 that defines a fuel inlet 13, a plurality of nozzle outlets 14 and a drain outlet 18. The term “injector body” is intended to encompass those components of fuel injector 10 that are fixed in position at all times. Thus, the injector body 11 includes multiple, but not all, of the components that make up fuel injector 10. Fuel injector 10 is illustrated as a common rail fuel injector for use in compression ignition engines, but could be a different type of fuel injector for a different type of engine. The common rail nature of fuel injector 10 is evidenced by fuel inlet 13 having a conical shaped seat to receive a quill for supplying high pressure from a common rail (not shown). Nozzle outlets 14 are opened and closed with a direct control needle valve 27 by relieving and applying pressure to a closing hydraulic surface 28 that is positioned in a needle control chamber 21. Fuel injector 10 may include a single solenoid actuator 30 that controls movement of a control valve member 25 with respect to a flat valve seat 22. When solenoid actuator 30 is de-energized, a biasing spring 48 causes a pin 37 to push control valve member 25 downward into contact with a flat seat 22. When solenoid actuator 30 is energized, pin 37 moves upward along centerline 19 to allow control valve member 25 to move out of contact with flat seat 22 to fluidly connect needle control chamber 21 to low pressure drain outlet 18. When this occurs, pressure acting on closing hydraulic surface 28 drops, and the direct control needle valve 27 lifts to an open position responsive to continuous high fuel pressure on opening hydraulic surface 26 to commence an injection event.

Solenoid actuator 30 includes an armature assembly 31 that moves as a unit with respect to a stator 32 between an initial air gap position and a final air gap position, such that the armature assembly 31 is always out of contact with stator 32. Armature assembly 31 and stator 32 are positioned in an actuator body 12, which is merely a subset of the components that make up injector body 11. Stator assembly 32 is typical in that it includes a coil winding, which may be surrounded by soft delicate, but highly magnetic material, sometimes referred to somaloy. The somaloy may be partially or fully enclosed by a magnetic metallic alloy with sufficient strength to support stator 32 under the expected clamping forces that exist to hold fuel injector 10 together. Although not necessary, stator 32 may be ground or otherwise manufactured to include a planar bottom surface 38. Armature assembly 31 includes a soft magnetic armature 35 and a hard non-magnetic stop piece 36 that may both be mounted to move as a unit with pin 37. The non-magnetic stop piece 36 is located further from the stator than the armature 35 so that the armature assembly 31 can be stopped outside of a magnetic flux circuit 55 through the stator 32 and the soft magnetic armature 35, when solenoid actuator 30 is energized. Preferably, the upper surface of soft magnetic armature 35 is planar and parallel to the bottom planar surface 38 of stator 32. Soft magnetic armature 35 may be made from powdered metal with good magnetic properties, but too soft to undergo repeated impacts. On the other hand, hard non-magnetic stop piece 36 may be a suitable steel alloy (e.g. stainless steel) that is hard to undergo repeated impacts, but that same hardness may undermine the ability of the stop piece 36 to be a good carrier of magnetic flux. Armature 35 and stop piece 36 may be attached to pin 37 in any suitable manner, such as for instance welding.

Injector body 11 includes a guide piece 15 that defines a guide bore 29 that receives pin 37. Thus, pin 37 undergoes a guide interaction with guide piece 15 to ensure that armature assembly 31 moves along centerline 19 between its initial and final air gap positions with respect to stator 32. When armature assembly 31 moves upward due to the energization of solenoid actuator 30, its movement is arrested when stop piece 36 comes in contact with a stop surface 20, which is located on a planar bottom of an annular stop spacer 16. Stop spacer 16 is stacked in contact with an annular air gap spacer 17, and both annular spacers 16 and 17 should be considered portions of the injector body 11 (or actuator body 12, for purposes of the present disclosure). Although not necessary, the annular air gap spacer 17 and annular stop spacer 16 may be clamped between the bottom planar surface 38 of stator 32 and a top surface of guide piece 15. Both of the annular spacers 16 and 17 have planar top and bottom surfaces separated by a wall of a relatively uniform thickness. The planar top and bottom surfaces are separated by a spacer distance. In terms of manufacturing, the annular stop spacer 16 may have a fixed spacer size, but the air gap spacer 17 may be a category part of various heights so that tolerance stack ups can be overcome by selecting an appropriate height spacer. This allows different fuel injectors to have different height spacers, but relatively uniform distances associated with the initial and final air gaps separating armature 35 from stator 32. This of course allows different fuel injectors 10 to respond more consistently with each other to the same control signals.

Although not necessary, fuel injector 10 may be equipped with an over travel spring 49, which is relatively weak relative to biasing spring 48. Over travel spring 49 allows the armature assembly 31 to continue downward travel after solenoid actuator 30 has been de-energized and control valve member 25 has come into contact with flat valve seat 22. This feature may serve to inhibit valve bouncing that could undermine settling times and/or lead to undesirable secondary injection events.

As best shown in FIG. 2, the soft magnetic armature 35 has a perimeter surface 40, which may be circular, surrounded by, but spaced from, an inner surface 41 of annular stop spacer 16. The separation between perimeter surface 40 and inner surface 41 might have a minimum distance that is greater than the separation distance between the armature 35 and stator 32 at the initial and final air gap positions. This spacing may help to encourage magnetic flux path 55 to stay in the stator 32 and soft magnetic armature 35 without substantial portions of the magnetic flux arcing over through annular spacer 16. Also shown in FIG. 2, the stop piece 36 has a perimeter surface 42 surrounded by, but spaced from, the annular air gap spacer 17. It should be pointed out that the soft magnetic armature 35 and the hard non-magnetic stop piece 36 may be attached to pin 37 at a relatively small radius 51, but stop surface 20 contacts stop piece 36 at a relatively large radius 52 from centerline 19. Those skilled in the art will appreciate that the one or both of the stop piece 36 and the annular stop spacer 16 may be coated at the contact surface with a layer of hardening material to further allow for repeated impacts without undermining performance of fuel injector 10.

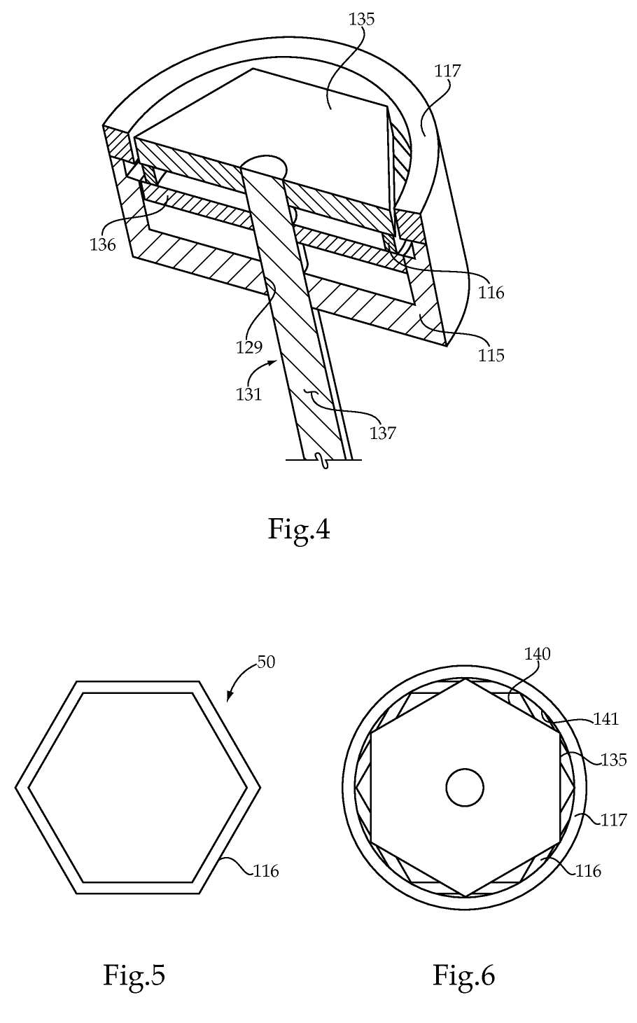

Referring now in addition to FIGS. 3-6, an alternative embodiment of an armature assembly 131 includes different features that may assist in the manufacturability of fuel injector 10. Like the earlier embodiment, armature assembly 131 includes a soft magnetic armature 135 and a hard non-magnetic stop piece 136 that are attached to a pin 137 that is guided in a guide bore 129 of a guide piece 115. This embodiment differs in that the armature 135 may have a perimeter surface 140 that has a non-circular shape that may be received through an inner surface of annular stop spacer 116. In particular, and in one specific example, annular stop spacer 116 may define a hexagonal inner surface just larger than a hexagonal perimeter surface 140 of armature 135. In this way, the armature assembly 131 may be fitted into guide piece 115 during the assembly of fuel injector 10. Thereafter, annular stop spacer 116 would be maneuvered from above past and over soft magnetic armature 135 to a position resting on a shoulder top surface of guide piece 115. Thereafter, the two components could be rotated out of phase, as best shown in FIG. 6. Next, the appropriate height air gap spacer 117 would be positioned atop stop spacer 116. Thereafter, the stator 32 would be clamped down into contact with an upper planar surface of annular air gap spacer 117. This embodiment differs in that the perimeter surface 140 of the soft magnetic armature 135 has a minimum spacing distance separating it from the inner surface 141 of the air gap spacer 117, whereas the earlier embodiment showed this spacing between the armature 135 and the stop spacer 116. This embodiment also differs in that the perimeter surface 142 of the stop piece 136 is separated at some minimum distance from an inner wall of guide piece 115. These spacings might be chosen to encourage the magnetic flux circuit 55 (FIG. 1) to stay between stator 32 and armature 135 rather than arcing over through one of the air gap spacers 17, 117 or stop spacers 16, 116. The embodiment of FIGS. 3-6 also differs in that the stop piece 136 and the annular air gap spacer 117 are located on opposite sides of the annular stop spacer 116 along centerline 19 of pin 137.

### INDUSTRIAL APPLICABILITY

The solenoid actuator of the present disclosure could find potential in applications that require short movement distances, fast action and short settling times. The solenoid actuator finds specific applicability in fuel injectors, and even more specific application in common rail fuel injectors to control relieving and applying pressure to a closing hydraulic surface of a direct control needle valve. The present disclosure is specifically applicable when the solenoid actuator utilizes relatively soft delicate, but highly magnetic materials that are not well suited to undergo repeated impacts during the operation of fuel injector 10. Thus, the present disclosure finds specific applicability when there is a desire to maintain the armature assembly out of contact with the stator throughout movement of the armature assembly from its initial air gap position to its final air gap position.

When fuel injector 10 is being operated, an injection event may be started by energizing solenoid actuator 30. The injection event may be ended by de-energizing solenoid actuator 30. When solenoid actuator 30 is energized, the armature assembly 31, 131 moves toward stator 32. The stator 32, and maybe armature 35, 135, are protected from impact damage by maintaining the armature assembly 31, 131 out of contact with the stator 32 at all times. In addition, inducement of residual magnetism in the armature assembly 31, 131 may be reduced by stopping the armature assembly 31, 131 outside of the magnetic flux circuit 55 through the stator 32 and a soft magnetic armature 35, 135 of the armature assembly 31, 131 when the solenoid actuator 30 is energized. As stated earlier, the armature assembly 31, 131 moves from the initial air gap position to the final air gap position responsive to energizing the solenoid actuator 30. In addition, pressure on the closing hydraulic surface 28 direct control needle valve 27 is relieved responsive to the armature assembly 31, 131 moving away from the initial air gap position. The armature assembly 31, 131 is stopped by contacting the stop piece 36, 136 with a stop surface 20, 120 of the injector body 11. Pressure on the closing hydraulic surface 28 is resumed responsive to de-energizing solenoid actuator 30 so that biasing spring 48 can act on pin 37, 137 to push control valve member 25 back downward into contact to close flat valve seat 22. When this is done, the fluid connection between the needle control chamber 21 and the drain outlet 18 is blocked.

The present disclosure presents a strategy for reducing impact damage to the soft magnetic components of a solenoid actuator. In addition, the disclosed strategy reduces inducement of residual magnetism in the armature assembly, which could otherwise make the armature assembly's movement back toward its initial air gap position sluggish following de-energization of the solenoid actuator.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A fuel injector comprising:
an injector body defining a fuel inlet and a plurality of nozzle outlets, and including a stop surface;
a direct control needle valve with a closing hydraulic surface positioned in a needle control chamber;
a solenoid actuator with an armature assembly that moves as a unit with respect to a stator between an initial air gap position and a final air gap position, such that the armature assembly is always out of contact with the stator;
the armature assembly including a soft magnetic armature and a hard non-magnetic stop piece, which is located further from the stator than the armature;
the stop piece being in contact with the stop surface at the final air gap position, but being out of contact with the stop surface at the initial air gap position.

2. The fuel injector of claim 1 wherein the injector body includes an annular stop spacer stacked in contact with an annular airgap spacer; and
the stop surface is located on a planar bottom of the annular stop spacer.

3. The fuel injector of claim 2 wherein the injector body includes a guide piece that defines a guide bore; and
the armature assembly includes a pin received in the guide bore to guide movement of the armature assembly between the initial and final air gap positions.

4. The fuel injector of claim 3 wherein the annular airgap spacer and the annular stop spacer are clamped between a bottom planar surface of the stator and the guide piece.

5. The fuel injector of claim 4 wherein the soft magnetic armature has a perimeter surface surrounded by, but spaced from, an inner surface of one of the annular airgap spacer and the annular stop spacer.

6. The fuel injector of claim 5 wherein the perimeter surface of the soft magnetic armature is surrounded by, but spaced from, the annular stop spacer; and
the hard non-magnetic stop piece includes a perimeter surface surrounded by, but spaced from, the annular airgap spacer.

7. The fuel injector of claim 5 wherein the perimeter surface of the soft magnetic armature is surrounded by, but spaced from, the annular airgap spacer; and
the stop piece and the annular airgap spacer are located on opposite sides of the annular stop spacer along a centerline of the pin.

8. The fuel injector of claim 7 wherein the perimeter surface of the soft magnetic armature has a non-circular shape; and
the inner surface of the annular stop spacer is sized to receive the perimeter surface of the soft magnetic armature therethrough.

9. The fuel injector of claim 1 wherein the injector body defines a drain outlet and includes a flat valve seat fluidly separating the needle control chamber from the drain outlet; and
a control valve member in contact with the flat valve seat and the armature assembly at the initial airgap position, but out of contact with the flat valve seat when the armature assembly is at the final airgap position.

10. A solenoid actuator for a fuel injector comprising:
an actuator body that includes a stop surface;
a stator assembly mounted to the actuator body and having a centerline;
an armature assembly that moves between an initial air gap position and a final air gap position;
the armature assembly including a soft magnetic armature and a hard non-magnetic stop piece that are each attached to a pin at a small radius from the centerline; and
the stop piece being in contact with the stop surface at a large radius from the centerline when at the final air gap position, but being out of contact with the stop surface at the initial air gap position.

11. The solenoid actuator of claim 10 wherein the actuator body includes an annular stop spacer stacked in contact with an annular airgap spacer;
the stop surface is located on a planar bottom of the annular stop spacer;
the actuator body includes a guide piece that defines a guide bore; and
the pin is received in the guide bore to guide movement of the armature assembly between the initial and final air gap positions.

12. The solenoid actuator of claim 11 wherein the soft magnetic armature has a perimeter surface surrounded by, but spaced from, an inner surface of one of the annular airgap spacer and the annular stop spacer; and
the annular airgap spacer and the annular stop spacer are clamped between a bottom planar surface of the stator and the guide piece.

13. A method of injecting fuel comprising the steps of:
starting an injection event by energizing a solenoid actuator;
ending the injection event by de-energizing the solenoid actuator;
the energizing step includes moving an armature assembly toward a stator;
protecting the stator from impact damage by maintaining the armature assembly out of contact with the stator; and
reducing inducement of residual magnetism in the armature assembly by stopping the armature assembly outside of a magnetic flux circuit through the stator and a soft magnetic armature of the armature assembly when the solenoid actuator is energized.

14. The method of claim 13 including a step of moving the armature assembly from an initial airgap position to a final airgap position responsive to energizing the solenoid actuator; and
relieving pressure on a closing hydraulic surface of a direct control needle valve responsive to the armature assembly moving away from the initial airgap position.

15. The method of claim 14 wherein the step of stopping the armature includes moving a hard non-magnetic stop piece of the armature assembly into contact with a stop surface of an injector body.

16. The method of claim 15 including a step of guiding movement of the armature assembly with a guide interaction between a pin of the armature assembly and a guide bore defined by a guide piece of the injector body.

17. The method of claim 16 including a step of resuming pressure on the closing hydraulic surface of the direct control needle valve responsive to de-energizing the solenoid actuator;
the resuming step includes pushing a control valve member with the pin into contact with a flat valve seat to block fluid communication between a needle control chamber and a drain outlet.

18. The method of claim 17 wherein the soft magnetic armature has a perimeter surface surrounded by, but spaced a minimum distance from, an inner surface of an annular spacer of the injector body; and
wherein the reducing step includes sizing the minimum distance to be greater than a separation distance between the soft magnetic armature and the stator when the armature assembly is at the final airgap position.

19. The method of claim 18 wherein the step of reducing inducement of residual magnetism includes maintaining the pin of the armature assembly out of contact with the stator.

20. The method of claim 19 including a step of setting a final airgap distance by stacking the annular spacer onto a second annular spacer.
